(19) United States
(12) Patent Application Publication
(10) Pub. No.: US 2006/0100356 A1
(43) Pub. Date: May 11, 2006

(54) Alicyclic carboxylic acid-containing functionalized polyolefins and emulsions prepared therefrom

(76) Inventors: Daniel W. Klosiewicz, Kingsport, TN (US); Stephen Wayne Coe, Longview, TX (US)

Correspondence Address: Eastman Chemical Company, P.O. Box 511, Kingsport, TN, 37662-5075, US

(21) Appl. No.: 11/235,433

(22) Filed: Sep. 26, 2005

Related U.S. Application Data
(60) Provisional application No. 60/614,087, filed on Sep. 29, 2004.
(60) Provisional application No. 60/614,156, filed on Sep. 29, 2004.
(60) Provisional application No. 60/614,138, filed on Sep. 29, 2004.
(60) Provisional application No. 60/614,097, filed on Sep. 29, 2004.

(51) Int. Cl. C08L 33/00

(52) U.S. Cl. 524/556

(57) ABSTRACT

Alicyclic carboxylic acid-containing functionalized polyolefins are provided in this invention. Emulsions comprising alicyclic carboxylic acid-containing functionalized polyolefins are also provided. Processes to produce the alicyclic carboxylic acid-containing functionalized polyolefins and functionalized polyolefin emulsions are also provided.

### CROSS REFERENCES TO RELATED APPLICATIONS

This application claims the benefit of United States Provisional Application entitled “Functionalized Polyolefin Emulsions” filed on Sep. 29^{th}, 2004 having Ser. No. 60/614,087, United States Provisional Application entitled “Processes for Producing Functionalized Polyolefin Emulsions” filed on Sep. 29^{th}, 2004 having Ser. No. 60/614,156, United States Provisional Application entitled “Alicyclic Carboxylic Acid-Containing Functionalized Polyolefins” filed on Sep. 29^{th}, 2004 having Ser. No. 60/614,138, United States Provisional Application entitled “Heat Stable Functionalized Polyolefin Emulsions” filed Sep. 29^{th}, 2004 having Serial No. 60,614,097, United States Original Application entitled “Functionalized Polyolefin Emulsions” filed on Jan. 7th, 2005 having Ser. No. 11/031920; United States Original Application entitled “Processes for Producing Functionalized Polyolefin Emulsions” filed on Jan. 7th, 2005 having Ser. No. 11/034362, and United States Original Application entitled “Heat Stable Functionalized Polyolefin Emulsions” filed on Jan. 7th, 2005 having Ser. No. 11/31727; all of which are hereby incorporated by reference in their entireties to the extent they do not contradict the statements herein.

### FIELD OF THE INVENTION

The present invention relates to alicyclic carboxylic acid-containing functionalized polyolefins. The present invention also relates to functionalized polyolefin emulsions comprising at least one alicyclic carboxylic acid-containing functionalized polyolefin, at least one non-ionic surfactant, at least one neutralizing base, optionally, at least one carboxylic acid co-surfactant, and water.

The present invention also relates to processes for producing alicyclic carboxylic acid-containing functionalized polyolefins, alicyclic carboxylic acid-containing functionalized polyolefin emulsions, and to articles comprising alicyclic carboxylic acid-containing functionalized polyolefins and/or emulsions.

### BACKGROUND OF THE INVENTION

Aqueous emulsions of various types of functionalized polyolefins have been used commercially since the late 1950s. Various methods for emulsifying low molecular weight polyolefins have been described by Force, in U.S. Pat. No. 3,912,673, von Bramer et al., “Polish Emulsion by Pressure Method,” Soap and Chemical Specialties, December, 1966, and Nalley et al., U.S. Pat. No. 3,655,353.

Emulsions of functionalized polyolefins have a variety of uses. For examples, emulsions of functionalized polyolefins are used in floor and car polishes, temporary metal coatings, corrugated and paper coatings, textile softener and lubricants, fiberglass sizing, and paper calendaring lubricants and citrus fruit coatings. However, the use of low molecular weight polyolefins in functionalized polyolefin emulsions can yield coatings having insufficient properties, such as, hardness. In addition, higher graft levels can increase color bodies in the functionalized polyolefins. Thus, there is a need for improved emulsions of high molecular weight functionalized polyolefins, in particular, emulsions of maleated polypropylene in order to improve, for example, mechanical properties and color.

Using current technology, it has been found that emulsifying high molecular weight functionalized polyolefins, especially maleated polypropylenes, has been extremely difficult. Generally, the difficulty of emulsifying a maleated polypropylene increases as the molecular weight and melt point of the maleated polypropylene increases. In addition, as the maleation level of the maleated polypropylene decreases, likewise the difficulty of emulsifying increases.

The use of functionalized polyolefins emulsions, particularly, maleated polypropylene emulsions, has particular use in sizing formulations for fibers, especially glass fibers to produce polymer/fiber composite materials. For example, sizing formulations based on emulsions of low molecular weight maleated polypropylene, such as Epolene E-43 maleated polypropylene produced by Eastman Chemical Company, have been used for a number of years to size glass fibers used to produce, for example, polypropylene/glass composite blends.

Various sizing formulations have been used in the fiber industry to maximize the fiber-polymer interaction. These sizing formulations include ingredients that collectively form an interphase between the fibers and the polymer. For glass fibers, the sizing formulation typically include a polymer, a silane, a lubricant, an antistatic agent, a functionalized polyolefin emulsion, for example, a maleated polypropylene emulsion, and other chemical ingredients.

Often times, the use of the low molecular weight polypropylene emulsions can cause the polypropylene/glass composite not to be strong enough to meet specifications. To enhance the polypropylene/glass composite properties, it has become common practice to add a high molecular weight functionalized polypropylene, as a coupling agent, in solid form during the compounding stage of the manufacturing process. However, there are drawbacks to this process. While emulsions of low molecular weight maleated polypropylene are effective for the sizing function, they can also interact with an aminosilane coupling agent applied with the glass fibers. This interaction can interfere with the interaction of the higher molecular maleated polypropylene coupling agent additionally added to the polypropylene/glass composite. The net effect is that this interaction of the low molecular weight maleated polypropylene emulsion with the aminosilane can negate to some extent the desired positive interaction of the higher molecular weight maleated polypropylene coupling agent with the glass fiber surface. This can reduce to some extent the mechanical properties of the polypropylene/glass composite.

If the higher molecular weight maleated polypropylene typically used as a coupling agent in these polypropylene/glass composites can be emulsified into useful sizing formulations, the size coating does not suffer from the drawback described above. Since the maleated polypropylene emulsion used in the size coating is similar in character to the maleated polypropylene serving as a coupling agent, the interaction of the size coating with the aminosilane glass surface does not produce the same negative interaction as when the maleated polypropylene size has very low molecular weight. The result is that the mechanical properties of the polypropylene/glass composite can be improved in this way.

Therefore, there is a need for functionalized polyolefin emulsions comprising high molecular weight, low graft level, functionalized polyolefins and processes for producing these emulsions.

### BRIEF SUMMARY OF THE INVENTION

It is an object of this invention to provide alicyclic carboxylic acid-containing functionalized polyolefins that can be utilized to produce functionalized polyolefin emulsions.

It is another object of this invention to provide functionalized polyolefin emulsions comprising the alicyclic carboxylic acid-containing functionalized polyolefins.

It is also another object of this invention to provide processes to produce alicyclic carboxylic acid-containing functionalized polyolefins.

It is also another object of this invention to provide processes to produce functionalized polyolefin emulsions.

It is a further object of this invention to provide sizing compositions comprising the functionalized polyolefin emulsions.

It is yet another object of this invention to provide articles comprising the alicyclic carboxylic acid-containing functionalized polyolefins and/or the functionalized polyolefin emulsions.

In accordance with one embodiment of this invention, an alicyclic carboxylic acid-containing functionalized polyolefin is provided comprising at least one alicyclic organic carboxylic acid and at least one functionalized polyolefin.

In accordance with another embodiment of this invention, a functionalized polyolefin emulsion is provided comprising at least one alicyclic carboxylic acid-containing functionalized polyolefin, at least one non-ionic surfactant, at least one carboxylic acid co-surfactant, at least one neutralizing base, and water.

In accordance with another embodiment of this invention, a process for producing an alicyclic carboxylic acid-containing functionalized polyolefin is provided comprising contacting a polyolefin, a functionalizing agent, at least one alicyclic carboxylic acid, and at least one initiator to produce the alicyclic carboxylic acid-containing functionalized polyolefin.

In accordance with another embodiment of this invention, an article is provided comprising the alicyclic carboxylic acid-containing functionalized polyolefin.

In accordance with yet another embodiment of this invention, an article is provided comprising the functionalized polyolefin emulsion.

When the alicyclic organic carboxylic acid is contained the functional polyolefin, a color improvement is observed as illustrated in the Examples. Furthermore, embodiments of this invention provide functionalized polyolefin emulsions comprising a functionalized polyolefin having a higher molecular weight and lower grafting level that has been previously thought of as being difficult or impossible to emulsify. The functionalized polyolefin emulsions of this invention exhibit at least one of the following advantages: 1) little residue after emulsification, 2) a small particle size thereby producing good transmittance for the diluted emulsion, 3) very fast filtration characteristics indicating minimal particles to clog filters, 4) high degree of reproducibility in the process for producing the functionalized polyolefin emulsions, 5) excellent coating characteristics, and 6) good color and color retention after heat aging.

### DETAILED DESCRIPTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

“Functional polyolefin emulsion” as used in this disclosure means that a functional polyolefin or an alicyclic carboxylic acid-containing functionalized polyolefin is used to produce the emulsion.

In one embodiment of the invention, an alicyclic carboxylic acid-containing functionalized polyolefin is provided comprising at least one alicyclic carboxylic acid and a functionalized polyolefin.

The alicyclic organic carboxylic acid can be any known in the art that can emulsify the functionalized polyolefin to produce a stable functionalized polyolefin emulsion. A stable functionalized polyolefin emulsion is one where the ingredients do not separate or the particles do not agglomerate. Examples of alicyclic organic carboxylic acid include, but are not limited to, rosin acids. Hydrogenated rosin acids, such as Foral AX-E rosin acid produced by Eastman Chemical Company, are particularly well suited for this invention because of the light color and stability imparted by hydrogenation.

The functionalized polyolefin will be discussed subsequently in this disclosure.

In one embodiment of this invention, a functionalized polyolefin emulsion is provided comprising at least one functionalized polyolefin, at least one non-ionic surfactant, at least one neutralizing base, at least one carboxylic acid co-surfactant, and water wherein the functionalized polyolefin has a grafting level ranging from about 0.5% by weight grafted functionalizing agent to about 2.5% by weight grafted functionalizing agent based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

In another embodiment of this invention, a functionalized polyolefin emulsion is provided comprising at least one alicyclic carboxylic acid-containing functionalized polyolefin, at least one non-ionic surfactant, at least one carboxylic acid cosurfactant, at least one neutralizing base, and water.

The alicyclic carboxylic acid co-surfactant can be contained in the functionalized polyolefin or added in the emulsification process. In another embodiment of the invention, the alicyclic carboxylic acid co-surfactant can be contained in the functionalized polyolefin and an additional amount of the alicyclic carboxylic acid co-surfactant can be added in the emulsification process.

The functionalized polyolefin can be any functionalized polyolefin that is known in the art. As used herein, functionalization of polyolefins refers to the addition of acid groups to the polyolefin by a functionalizing agent. Functionalization can be achieved by any method known in the art. For example, thermal oxidation and grafting are processes that can be utilized.

In one embodiment of the invention, the polyolefins to be functionalized comprise at least one olefin monomer having from 2 to about 8 carbon atoms, preferably from 2 to about 6 carbon atoms. Examples of such polyolefins include, but are not limited to, polyethylene, polypropylene, polybutene, and polyhexene. The polyolefins to be functionalized can be homopolymers, copolymers, or terpolymers. Preferred polyolefins are homopolymers and copolymers of low, medium, and high density polyethylene and homopolymers and copolymers of crystalline and amorphous polypropylenes. More preferred are crystalline homopolymers or copolymers of propylene. Other suitable polyolefins, include, but are not limited to, thermoplastic elastomers such as ethylene-propylene rubber (EPR) and ethylene-propylene-diene rubber (EPDM).

The functionalizing agent can be any that are known in the art. In one embodiment, the functionalizing agent can be any unsaturated monomer containing one or more carboxylic acid or acid anhydride groups that can functionalize the polyolefin. Examples of suitable functionalizing agents are carboxylic acids, such as, acrylic acid and methacrylic acid, and acid anhydrides, such as, maleic anhydride. Further functionalizing agents include, but are not limited to, unsaturated monocarboxylic acids, polycarboxylic acids, and cyclic acid anhydrides. Specifically included herein are acids, such as, maleic acid, flumaric acid, himic acid, itaconic acid, citraconic acid, mesaconic acid, acrylic acid, methacrylic acid, crotonic acid, isocrotonic acid, and acid anhydrides, such as, maleic anhydride and himic anhydride. In one embodiment of this invention, the use of maleic anhydride is preferred for the functionalization of polypropylene. Mixtures of functionalizing agents may be utilized in the present invention.

Polyolefins having a grafting level of about 0.5% by weight to about 2.5% by weight grafted functionalizing agent based on the weight of the functionalized polyolefin can be emulsified in this invention. Preferably, the grafting level can range from about 1.2% by weight to about 2% by weight grafted functionalizing agent based on the weight of the functionalized polyolefin. When the functionalized polyolefin is maleated polypropylene, the grafting level can range from about 0.5% by weight to about 2.5% by weight grafted maleic anhydride, preferably from about 1% by weight to about 2.5% by weight, and most preferably from 1.3% by weight to 2.0% by weight of grafted maleic anhydride based on the weight of the maleated polypropylene. The graft level (% by weight grafted functionalizing agent based on the weight of the functionalized polyolefin) is calculated from the acid number. Lower graft levels result in maleated polypropylene having lighter color, which can be advantageous in certain applications. In addition, lower graft levels can also minimize polymer degradation.

In one embodiment of the invention, the graft distribution of the functionalized polyolefin should be with good uniformity in order to produce high quality functionalized polyolefin emulsions. For example, with maleated polypropylene, where the maleic anhydride reacts to form highly grafted oligomeric species and a substantial amount of the polyolefin remains unmodified, the functionalized polyolefin can be difficult or impossible to emulsify even though the graft level, calculated from the acid number, may indicate maleic anhydride content in the desired range.

The grafting level is calculated from the acid number of the functionalized polyolefin. The acid number of a functionalized polyolefin is the number of milligrams of potassium hydroxide that is required to neutralize the functional group present in 1 gram of the functionalized polyolefin where the test is designed to consume 1 millimole of potassium hydroxide for every millimole of functional group present. For example, when titrating grafted maleic anhydride groups, methanolic potassium hydroxide is used so that each maleic functionality consumes only one potassium hydroxide even though maleic anhydride can form a diacid. The acid number is obtained by titrating weighed samples of functionalized polyolefin dissolved in refluxing xylene with methanolic potassium hydroxide using phenolphthalein as an indicator. The acid number is distinguished from the saponification number which is measured in an aqueous system while the acid number is measured in a water-free system. By using an aqueous system for the titration of the functionalized polyolefin, the functionalizing agent is hydrolyzed, and twice the amount of potassium hydroxide is needed for neutralization. Therefore, the saponification number is twice as high as the acid number.

To produce functionalized polyolefin emulsions, the acid number of the functionalized polyolefin can range from about 4 to about 14, preferably from 6 to 12. Acid numbers for maleated polypropylene can range from about 4 to about 14, preferably from 7 to 12.

Polymer strength is positively correlated with molecular weight; therefore, higher molecular weight functionalized polyolefins generally can have more desirable physical properties than lower molecular weight functionalized polyolefins. In one embodiment of this invention, the weight average molecular weight of the functionalized polyolefin can range from about 30,000 to about 90,000, preferably ranging from 40,000 to 70,000 for most of the uses described previously. The weight average molecular weight for maleated polypropylene can range from about 30,000 to about 90,000, preferably from 40,000 to 70,000.

The melt viscosity at 190° C. of the functionalized polyolefin is that which is sufficient to obtain properties useful in the application for the functionalized polyolefin emulsion. The melt viscosity at 190° C. was measured using a Thermosel viscometer manufactured by the Brookfield Instrument Company. In one embodiment of this invention, the melt viscosity at 190° C. is greater than 10,000 centipoise, preferably ranging from about 20,000 centipoise to about 150,000 centipoise, and most preferably ranging from 40,000 centipoise to 100,000 centipoise. The melt viscosity for maleated polypropylene can range from about 20,000 to about 150,000, preferably from 40,000 to 100,000.

The peak melt point measured by differential scanning calorimetry of the functionalized polyolefin is that which is sufficient to obtain properties useful in the particular application for the functionalized polyolefin emulsion. In one embodiment of this invention, the peak melt point of the functionalized polyolefin is greater than about 135° C., preferably greater than 150° C. The peak melt point for maleated polypropylene can range from about 135° C. to about 165° C., preferably from 155° C. to 165° C.

The amount of the functionalized polyolefin contained in the functionalized polyolefin emulsion is that which is sufficient to obtain properties useful in the particular application of the functionalized polyolefin emulsion. In one embodiment of this invention, the amount of the functionalized polyolefin can range from about 10% by weight to about 35% by weight based on the weight of the functionalized polyolefin emulsion, preferably from 20% by weight to 30% by weight. For maleated polypropylene emulsions, the amount of maleated polypropylene can range from about 10% by weight to about 35% by weight based on the weight of the maleated polypropylene emulsion, preferably from 20% by weight to 30% by weight.

The functionalized polyolefin can be produced by any process known in the art. The process can be either batch or continuous. In a batch process, generally, all of the reactants and products are maintained in the reaction vessel for the entire batch preparation time. In a continuous process, the ingredients are feed at a continuous rate to the process.

Typical processes for producing functionalized polyolefins include, but are not limited to, solid phase, solvent, or extrusion processes. In a solid phase process, the polyolefin is heated to a temperature below the melting point of the polyolefin. Then, the functionalizing agent and initiator are added to the heated polyolefin to produce the functionalized polyolefin. U.S. Pat. Nos. 4,595,726 and 5,140,074, herein incorporated by reference in their entirety to the extent they do not contradict the statements herein, utilize the solid phase process.

In solvent processes, solvent is added to swell the polyolefin to allow functionalization by the functionalizing agent. U.S. Pat. Nos. 4,675,210 and 4,599,385, herein incorporated by reference in their entirety to the extent they do not contradict the statements herein, utilize the solvent process.

In extrusion processes, the polyolefin, functionalizing agent, and at least one initiator are fed to an extrusion zone where grafting takes place. The extrusion zone comprises at least one extruder. U.S. Pat. Nos. 5,955,547, 6,046,279, and 6,218,476, herein incorporated by reference in their entirety to the extent they do not contradict the statements herein, describe extrusion processes for producing functionalized polyolefins, particularly maleated polypropylenes.

The functionalized polyolefins, particularly maleated polypropylene, can also be characterized into two product types as a function of whether or not solvent is utilized, either as a solvent during reaction or in workup of the functionalized polyolefins. In U.S. Pat. Nos. 3,414,551; 4,506,056; and 5,001,197, herein incorporated by reference in their entirety to the extent they do not contradict the statements herein, the workup of the functionalized polyolefin involves dissolving the functionalized polyolefin in a solvent followed by precipitation, or washing with solvent. This treatment removes soluble components and thus varies both the ‘apparent’ molecular weight and acid number.

In one particular embodiment of this invention, the maleated polypropylene is prepared by an extrusion process utilizing a polypropylene having a peak melt point greater than 135° C. The polypropylene is combined in the melt with maleic anhydride that is added at a level between about 1.0 parts to about 2.5 parts per 100 parts of polypropylene, and the peroxide initiator is added at a level up to about 2.0% by weight based on weight of the polypropylene. The polypropylene, maleic anhydride, and peroxide initiator are mixed in the extruder at a temperature in the range of about 160° C. to about 250° C. The maleated polypropylene after stripping to remove unreacted maleic anhydride generally exhibits greater than, about 1.2% reacted (grafted) maleic anhydride measured by acid titration using methanolic KOH.

In one embodiment of this invention, a functionalized polyolefin emulsion is provided comprising at least one functionalized polyolefin, at least one non-ionic surfactant, at least one neutralizing base, optionally, at least one carboxylic acid co-surfactant, and water wherein the functionalized polyolefin has a grafting level ranging from about 0.5% by weight grafted functionalizing agent to about 2.5% by weight grafted functionalizing agent based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

The non-ionic surfactant used should have the proper HLB characteristics based on the graft level of the functionalized polyolefin to produce a stable functionalized polyolefin emulsion. A stable functionalized polyolefin emulsion was defined previously in this disclosure. Preferably, the functionalized polyolefin emulsion has a transmittance greater than 5%. The method of measuring transmittance is described subsequently in the examples section of this disclosure.

For non-ionic surfactants, which are amphiphallic and comprised of both a hydrophobic end and a hydrophillic ethylene oxide segment, HLB is an indicator of the relative amounts of hydrophillic and hydrophobic segments in the surfactant. The percentage of hydrophillic groups in the surfactant is roughly equal to (HLB/20)×100. For example, a non-ionic surfactant with a HLB equal to 10 has about 50% of its molecules consisting of polar ethylene oxide groups while a non-ionic surfactant with a HLB equal to 15 has about 75% of its structure as polar ethylene oxide units.

To emulsify functionalized polyolefins with graft levels greater than 2.5% by weight functionalizing agent based on the weight of the functionalized polyolefin, such as Epolene E-43 or G-3015 maleated polypropylene produced by Eastman Chemical Company, a non-ionic surfactant with a HLB value of about 11 to about 15 is typically used. Functionalized polyolefins having lower grafting level and higher molecular weight are more difficult to emulsify. In order to emulsify functionalized polyolefins having a graft level less than or equal to about 2.5% by weight functionalizing agent based on the weight of the functionalized polyolefin, it would be expected that non-ionic surfactants having higher HLB values should be utilized, but this is surprisingly not the case as discussed subsequently and as shown in the examples in this disclosure.

For example, Epolene G-3003 maleated polypropylene produced by Eastman Chemical Company with about 1.4 weight % grafted maleic anhydride based on the weight of the maleated polypropylene emulsifies well using non-ionic surfactants or mixtures of non-ionic surfactants having an average HLB value of between about 8 and about 9. As the grafting level of the functionalized polyolefin increases, the optimum HLB of the non-ionic surfactant increases with the increasing graft level in order to produce the optimum functionalized polyolefin emulsion as indicated by good transmittance and filterability. Good transmittance and filterability are defined in the Examples Section of this disclosure. For instance, the optimum HLB for the non-ionic surfactant to emulsify Epolene G-3015 maleated polypropylene produced by Eastman Chemical Company with about 3% grafted maleic anhydride ranges from about 11 to about 14. However, these same non-ionic surfactants fail to produce a stable functionalized polyolefin emulsion when used with Epolene G-3003 maleated polypropylene having a 1.4% grafting level.

When emulsifying functionalized polyolefins have a grafting level between about 0.5% by weight grafted functionalizing agent to about 2.5% by weight grafted functionalizing agent based on the weight of the functionalized polyolefin, the non-ionic surfactant can be any non-ionic surfactant or mixture of non-ionic surfactants known in the art having a HLB ranging from about 4 to about 10. As mentioned previously, optimal functionalized polyolefin emulsions are obtained by choosing the appropriate HLB range based on the grafting level of the functionalized polyolefin. Preferably, the HLB value of the non-ionic surfactant can range from about 6 to about 10, and most preferably from 7 to 10.

Preferably, non-ionic surfactants or non-ionic surfactant mixtures with a HLB value in the range of about 8 to about 9 tend to be most effective when emulsifying Epolene G-3003 maleated polypropylene. Most preferably, the non-ionic surfactant for producing emulsions of Epolene G-3003 maleated polypropylene (1.4 wt % maleic anhydride based on the weight of the maleated polypropylene) produced by Eastman Chemical Company is a roughly 70/30 mixture of Brij 30 and Brij 72 obtained from Uniquema Chemical Company where the calculated HLB of the blend is about 8.5. It has been found that non-ionic surfactants with even lower HLB values than 8.5 tend to require higher levels of carboxylic acid co-surfactant to produce stable emulsions.

Non-ionic surfactants include, but are not limited to, compounds based on ethylene oxide and alkyl phenols. Particular examples of suitable non-ionic surfactants include, but are not limited to, ethoxylated derivatives of C₈ to C₂₀ synthetic linear alcohols, ethoxylated C₉ to C₁₈ synthetic branched alcohols, ethoxylated alkyl phenol derivatives, mono esters of aliphatic carboxylic acids and polyethylene oxide oligomers of varying molecular weight, and similar mono- or di-esters of polyhydroxy material, such as, sorbitol-monolaurate. Of this group, non-ionic surfactants based on the reaction of alcohols or alkyl phenols with ethylene oxide, propylene oxide, or mixtures of the two are most preferred because of the stability of the ether linkage joining the hydrophilic and hydrophobic ends. Combinations of non-ionic surfactants can also be used. For example, combinations of non-ionic surfactants having high and low HLB values can be utilized to arrive at the HLB necessary to emulsify a particular functionalized polyolefin.

The amount of non-ionic surfactant present in the functionalized polyolefin emulsion is that which is sufficient to obtain a stable functionalized polyolefin emulsion. A stable functionalized polyolefin emulsion was previously defined in this disclosure. Preferably, the amount of the non-ionic surfactant present in the functionalized polyolefin emulsion is that which is sufficient to obtain an acceptable emulsion as indicated by a transmittance of at least 5%. In one embodiment, the amount of non-surfactant can range from about 6 parts by weight per 100 parts by weight of functionalized polyolefin to about 25 parts by weight per 100 parts by weight of functionalized polyolefin, preferably from about 10 to about 20, and most preferably from 12 to 18.

The carboxylic acid co-surfactant is at least one selected from the group consisting of linear organic carboxylic acids and alicyclic organic carboxylic acids. The term “linear organic carboxylic acid” means any carboxylic acid structure which contains no cyclic or multi-cyclic groups and can include branched structures with no cyclic units. While not intended to be bound by any particular theory, the carboxylic acid co-surfactant is neutralized by the neutralizing base to form an anionic surfactant species. The linear organic carboxylic acid can be any known in the art that can emulsify the functionalized polyolefin to produce a stable functionalized polyolefin emulsion. A stable functionalized polyolefin emulsion was previously defined in this disclosure. Preferred examples of linear organic carboxylic acids include, but are not limited to, linear C₁₆ to C₁₈ fatty acids, such as, for example, oleic, stearic, or palmitoleic acid.

Alicyclic organic carboxylic acids were previously discussed in this disclosure.

In one embodiment of the invention, when emulsifying a functionalized polyolefin having a grafting level ranging from about 0.5% by weight to about 2.5% by weight grafted functionalizing agent based on the weight of the functionalized polyolefin, the amount of linear organic carboxylic acid is less than or equal to about 16 parts per 100 parts of functionalized polyolefin. Addition of an alicyclic organic carboxylic acid is not needed to obtain a stable functionalized polyolefin emulsion when the amount of the linear organic carboxylic acid is less than or equal to 16 parts per 100 parts of functionalized polyolefin. Preferably, when used alone in the emulsion formulation without an alicyclic carboxylic acid, the amount of linear organic carboxylic acid can range from about 2 to about 16 parts per hundred parts of functionalized polyolefin, most preferably from 8 to 12. It was surprising that the use of levels of linear organic carboxylic acid greater than 16 parts per 100 parts of functionalized polyolefin hindered emulsification and produced poorer quality emulsions as shown in the examples section.

However, when emulsifying functionalized polyolefins having a grafting level ranging from about 0.5% by weight to about 2.5% by weight grafted functionalizing agent based on the weight of the functionalized polyolefin and using a linear organic carboxylic acid in an amount less than or equal to 16 parts per hundred parts of functionalized polyolefin, improved emulsion properties, such as transmittance, can be obtained when at least one alicyclic organic carboxylic acid is also utilized in combination with the linear organic carboxylic acid. It is preferred to use mixtures of alicylic organic carboxylic acids with linear organic carboxylic acids when the total level of carboxylic acid co-surfactant in the emulsion is greater than 8 parts per hundred parts of functionalized polyolefin. When using both a linear organic carboxylic acid and alicyclic organic carboxylic acid, the total amount of carboxylic acid co-surfactant in the functionalized polyolefin emulsion is preferably in the range from about 8 parts to about 25 parts per hundred parts of functionalized polyolefin, most preferably, from 10 to 16. To obtain these improved emulsion properties, the amount of the alicyclic organic carboxylic acid can range from about 1% by weight to about 99% by weight of the total amount of carboxylic acid co-surfactant, preferably from 25% by weight to 75% by weight.

In another embodiment of this invention, it has been found that when the total amount of carboxylic acid co-surfactant is greater than 16 parts per 100 parts of functionalized polyolefin for functionalized polyolefins with grafting levels between about 0.5% by weight to about 2.5% by weight grafted functionalizing agent based on the weight of the functionalized polyolefin, the addition of alicyclic organic carboxylic acid, such as rosin acid, aids in the emulsification of the functionalized polyolefin whereas further addition of linear organic carboxylic acid deteriorates emulsion quality. In one embodiment of this invention, when the total amount of carboxylic acid co-surfactant is greater than 16 parts per hundred parts of functionalized polyolefin, the maximum amount of linear organic carboxylic acid should be 16 parts per hundred parts functionalized polyolefin and the remainder of the carboxylic acid co-surfactant should be alicylic organic carboxylic acid.

In another embodiment of this invention, the carboxylic acid co-surfactant is at least one alicyclic organic carboxylic acid. The amount of the alicyclic organic carboxylic acid is that which is sufficient to produce a stable functionalized polyolefin emulsion. A stable functionalized polyolefin emulsion was previously defined in this disclosure. In one embodiment of the invention, the amount of the alicyclic organic carboxylic acid can range from about 5 parts to 25 parts per hundred parts of functionalized polyolefin, preferably from 10 parts to 16 parts.

As mentioned previously, the alicyclic organic carboxylic acid can be contained in the functionalized polyolefin, added in the emulsification process, or both contained in the functionalized polyolefin and additional alicyclic organic carboxylic acid added during the emulsification process.

To emulsify the functionalized polyolefin, a neutralizing base is also used. While not intended to be bound by any particular theory, it is believed that the neutralizing base neutralizes the carboxylic acid co-surfactant to form a soap which acts as an emulsifier. It is also believed that the neutralizing base neutralizes functional groups on the functionalized polyolefin. Preferred bases are organic compounds having 1 to about 10 carbon atoms, an amino group, and a hydroxyl group. Preferred bases include, but are not limited to, N,N-diethylethanolamine, N,N-dimethyl ethanolamine, 2-dimethylamino-2-methyl-1 propanol, 2-dimethylamino-1-propanol, or combinations thereof.

Additionally, when a maleated polypropylene emulsion is dried, the neutralizing base can be volatile enough that it evaporates, which can allow the anhydride group in the maleated polypropylene to reform at higher temperatures. This behavior can be important in fiberglass sizing applications because the emulsion size can be reconverted to the anhydride form during drying, allowing the maleated polypropylene to also serve as coupling agent directly deposited onto the glass fiber.

The amount of neutralizing base is that which is sufficient to convert a portion of the carboxylic acid co-surfactant to an anionic surfactant and to neutralize a portion of the acid groups of the functionalized polyolefin. Generally, the amount of the neutralizing base in the functionalized polyolefin emulsion is not a fixed amount but depends on the total acidity of the functionalized polyolefin emulsion where the acidity is the combination of the carboxylic acid co-surfactant and the acidity of the grafted functional groups and the acidity of any emulsion additives. It is preferred that enough neutralizing base be used to neutralize about 80% to 100% of the total acidity in the functionalized polyolefin emulsion.

The remainder of the functionalized polyolefin emulsion is water.

In another embodiment of this invention, a functionalized polyolefin emulsion is provided comprising at least one functionalized polyolefin or at least one alicyclic carboxylic acid-containing functionalized polyolefin, at least one non-ionic surfactant, at least one neutralizing base, optionally, at least one carboxylic acid co-surfactant, and water; wherein the functionalized polyolefin has a grafting level from about 0.5% by weight to about 2.5% by weight grafted functionalizing agent based on the weight of the functionalized polyolefin; and wherein the carboxylic acid co-surfactant comprises at least one alicyclic carboxylic acid.

The functionalized polyolefin and at least one neutralizing base were previously discussed in this disclosure.

The non-ionic surfactant was also previously discussed in this disclosure and is selected based on the graft level of the functionalized polyolefin.

The carboxylic acid co-surfactant is at least one alicyclic organic carboxylic acid. Alicyclic organic carboxylic acids were discussed previously in this disclosure. In another embodiment of this invention, the carboxylic acid co-surfactant is at least one linear organic carboxylic acid and at least one alicyclic organic carboxylic acid.

In another embodiment of this invention, a functionalized polyolefin emulsion is provided comprising at least one functionalized polyolefin or at least one alicyclic carboxylic acid-containing functionalized polyolefin, at least one non-ionic surfactant, at least one neutralizing base, optionally, at least one carboxylic acid co-surfactant, and water; wherein the functionalized polyolefin has a grafting level from about 0.5% by weight to about 2.5% by weight grafted functionalizing agent based on the weight of the functionalized polyolefin; and wherein the functionalized polyolefin emulsion has a % transmittance of at least 5%. The functionalized polyolefin emulsion can also have good filterability. Good filterability is defined subsequently in the examples section of this disclosure.

In another embodiment of the invention, the size of the emulsion particles is so fine that the functionalized polyolefin emulsion can be filtered easily to produce a very clean product for making fine coatings. Particles larger than the pores of a filter element cause the filter to become clogged, making filtration very difficult. The functionalized polyolefin emulsion has good filterability if it passes the filterability test described subsequently in this disclosure.

Generally, the functionalized polyolefin emulsions have a transmittance value greater than 5%, preferably greater than 15%, and most preferably greater than 30%.

It is highly desirable that maleated polypropylene emulsions exhibit transmittance values greater than 5%, preferably greater than 10%, more preferred are maleated polypropylene emulsions with a transmittance greater than 20%, while the most desirable maleated polypropylene emulsions exhibit transmittance values greater than 30%. Emulsions of maleated polypropylene can be made which exhibit transmittance values of 60% or greater, particularly if the polypropylene is maleated to a higher degree usually having a grafting level of greater than 2%. Maleated polypropylene emulsions with transmittance values ranging from about 20% to about 35% or higher typically exhibit the coating and filtration behavior desired for emulsions of this type.

The alicylic carboxylic acid-containing functionalized polyolefin can be produced by any method known in the art. In one embodiment of the invention, a process is provided for producing an alicyclic carboxylic acid-containing functionalized polyolefin comprising contacting at least one polyolefin, at least one functionalizing agent, at least one alicyclic carboxylic acid, and at least one initiator to produce the alicyclic carboxylic acid-containing functionalized polyolefin.

In another embodiment of the invention, a process is provided for producing alicyclic carboxylic acid-containing functionalized polyolefins comprising: 1) heating at least one polyolefin and optionally, at least one alicyclic carboxylic acid, in a melting zone to produce a molten polyolefin; 2) contacting the molten polyolefin with at least one functionalizing agent and optionally, at least one alicyclic carboxylic acid, in a first mixing zone to produce a functionalizing agent/polyolefin mixture; 3) contacting the functionalizing agent/polyolefin mixture with at least one initiator and optionally, at least one alicyclic carboxylic acid in a second mixing/reaction zone to produce the alicyclic carboxylic acid-containing functionalized polyolefin. The alicylic carboxylic acid can be added in either step a), step b), or step c). Preferably, the alicyclic carboxylic acid is rosin acid, more preferably, hydrogenated rosin acid.

In another embodiment of the invention, a process is provided for producing alicyclic carboxylic acid-containing maleated polypropylene comprising contacting polypropylene, maleic anhydride, at least one alicyclic carboxylic acid, and at least one initiator in an extrusion zone to produce the alicyclic carboxylic acid-containing maleated polypropylene. The alicyclic carboxylic acid can be added at any time during the process. Preferably, the alicyclic carboxylic acid is rosin acid, more preferably, hydrogenated rosin acid.

In another embodiment of the invention, a process is provided for producing rosin acid-containing maleated polypropylene comprising: 1) heating polypropylene and optionally, at least one rosin acid, in a melting zone to produce molten polypropylene; 2) contacting the molten polypropylene with maleic anhydride and optionally, at least one rosin acid, in a first mixing zone to produce a maleic anhydride/polypropylene mixture; 3) contacting the maleic anhydride/polypropylene mixture with at least one initiator and optionally, at least one rosin acid in a second mixing/reaction zone to produce the rosin acid-containing maleated polypropylene. The rosin acid can be added in either step a), step b), or step c). Preferably, the rosin acid is hydrogenated.

The functionalized polyolefin emulsion of this invention can be produced by any method known in the art. The alicyclic carboxylic acid can be contained in the functionalized polyolefin, can be added in the emulsification process, or can be contained in the functionalized polyolefin and additional alicyclic carboxylic acid can be added in the emulsification process. In one embodiment of the invention, a process to produce a functionalized polyolefin emulsion is provided comprising heating at least one functionalized polyolefin, at least one non-ionic surfactant, at least one neutralizing base, optionally, at least one carboxylic acid co-surfactant, and water to produce the functionalized polyolefin emulsion; wherein the functionalized polyolefin has a grafting level ranging from about 0.5% by weight grafted functionalizing agent to about 2.5% by weight functionalizing agent based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts per hundred parts of the functionalized polyolefin.

In another embodiment of this invention, a process is provided to produce a functionalized polyolefin emulsion comprising heating at least one functionalized polyolefin, at least one non-ionic surfactant, at least one neutralizing base, optionally, at least one carboxylic acid co-surfactant, and water to produce the functionalized polyolefin emulsion; wherein the functionalized polyolefin has a grafting level ranging from about 0.5% by weight grafted functionalizing agent to about 2.5% by weight functionalizing agent based on the weight of the functionalized polyolefin; wherein the non-ionic surfactant has a HLB ranging from about 4 to about 10; wherein the carboxylic acid co-surfactant comprises at least one linear organic carboxylic acid and at least one alicyclic organic carboxylic acid; and wherein the total amount of the carboxylic acid co-surfactant is in an amount greater than 16 parts per hundred parts of the functionalized polyolefin.

In another embodiment of this invention, a process is provided to produce a functionalized polyolefin emulsion comprising heating at least one functionalized polyolefin, at least one non-ionic surfactant, at least one neutralizing base, optionally, at least one carboxylic acid co-surfactant, and water to produce the functionalized polyolefin emulsion, wherein the carboxylic acid co-surfactant comprises at least one alicyclic carboxylic acid.

In another embodiment of this invention, a process is provided to produce a functionalized polyolefin emulsion comprising heating at least one functionalized polyolefin, at least one non-ionic surfactant, at least one neutralizing base, optionally, at least one carboxylic acid co-surfactant, and water to produce the functionalized polyolefin emulsion; wherein the functionalized polyolefin has a grafting level from about 0.5% by weight grafted functionalizing agent to about 2.5% by weight grafted functionalizing agent based on the weight of the functionalizing polyolefin; and wherein the functionalized polyolefin emulsion has a % transmittance of at least 5%.

In all of these processes described previously to produce functionalized polyolefin emulsions, the emulsion can be produced by either a direct or indirect method. In a direct or batch method, the functionalized polyolefin, at least one non-ionic surfactant, at least one neutralizing base, optionally, at least one carboxylic acid co-surfactant, and water are added to an emulsification vessel at the start of the batch to produce an emulsification mixture. The emulsification vessel is then heated to the desired emulsification temperature under the vapor pressure of the water. The temperature of the emulsification mixture is generally above the melting point of the functionalized polyolefin. The temperature of the emulsification mixture can range from about 140° C. to about 185° C. depending on the melting point of the functionalized polyolefin, prefererably from 165° C. to 180° C.

An advantage of the direct method is there is no need to charge materials to the emulsification vessel in separate steps while it is under pressure. In addition, it is simple process that eliminates additional steps that add cost to the production of the functionalized polyolefin emulsion.

In the indirect method, first, the functionalized polyolefin and a portion of at least one of the other emulsion ingredients are heated above the melting point of the functionalized polyolefin, then the remaining emulsion ingredients are added in any order or combination at elevated temperatures.

### EXAMPLES

This invention can be further illustrated by the following examples of preferred embodiments thereof, although it will be understood that these examples are included merely for purposes of illustration and are not intended to limit the scope of the invention unless otherwise specifically indicated.

Test Methods

Filterability was measured by filtering the functionalized polyolefin emulsion through a fine paint strainer, having a 48×64 mesh filtration area such as Product # ST-9014 sold by Paul Gardner Company, Inc. Acceptable filterability was found if the functionalized polyolefin emulsion flowed completely through the strainer within about 1-2 seconds after the amount of functionalized polyolefin emulsion (approx. 220 g) was poured into the strainer. Poor filterability was found if the functionalized polyolefin emulsion (approx. 220 g) required greater than about 10 seconds to drain through the filter, and the rate could be noted to slow as agglomerates or gels caused the porous screen to clog. In the worse case, the filtration would essentially stop as the filter area became completely blocked.

Transmittance of the functionalized polyolefin emulsion was measured by diluting the functionalized polyolefin emulsion to 1% in deionized water by mixing 1 gram of functionalized polyolefin emulsion with 99 grams of deionized water to produce a diluted emulsion. The diluted emulsion was transferred into a 13×100 mm test tube, and the % transmittance was measured using a laboratory spectrophotometer such as a Sequoia Turner Model 340 spectrophotometer obtained from Sequoia Turner or Spectronic 21 D spectrophotometer obtained from Milton Roy operating at a wavelength of 600 nm. Samples were tested using calibration and test procedures documented in the manufacturer operating literature supplied with the instruments. These test instruments measure the amount of light of a specific wavelength which passes through the 13 mm sample path as compared to pure water with nominal 100% transmittance.

As the size of the emulsion particles decreases and larger particles in the emulsion are eliminated, the functionalized polyolefin emulsion becomes more translucent in appearance and the % transmittance increases. Functionalized polyolefin emulsions with % transmittance values less than about 10% tend to be very coarse emulsions which typically exhibit poorer filtration characteristics and give a rough coating suggesting the presence of gels or grit when a glass slide is coated with the emulsion and allowed to dry in an inverted position to form a thin film.

Recovered Emulsion Yield (%) was calculated by weighing the functionalized polyolefin emulsion produced after filtration in grams and dividing by 216 grams. 220 grams of material were added to the reactor, and 4 grams were assumed to have accumulated in the equipment and filter when transferring and filtering the functionalized polyolefin emulsion.

Residue was determined by removing and weighing the solids in the emulsification vessel before and after drying.

Overall Emulsion Quality was determined qualitatively by considering the amount of residue, transmittance, and filterability of the functionalized polyolefin emulsion.

### Comparative Example 1 and Inventive Examples 1-4

### Preparation of Rosin Acid-Containing Maleated Polypropylene

Rosin acid-containing maleated polypropylene was produced utilizing a Berstorff ZE25 mm×63 L/D twin screw extruder. The extruder had 1 chilled glycol cooled feed barrel followed in series by 12 additional barrels that were electrically heated and air cooled. The barrels were numbered such that barrel number 1 was the first heated barrel unit following the cooled feed barrel; barrel number 2 was the second barrel after the feed barrel and so on. Standard temperature controllers were used to control the set point temperature of the 12 heated barrels. For this series of experiments, Barrels 1 through 12 were set at a flat 177 degree centigrade temperature profile.

In all experiments, a Prorate volumetric feeder was used to feed the polypropylene to the extruder. In cases where other additives were used (e.g. Foral AX rosin acid), a tumble blend was made ahead of time with the polypropylene pellets and the volumetric feeder was used to feed the solid mix. Care was taken to minimize vibration of the hopper to minimize segregation of the feed components.

In all experiments, the peroxide used as the initiator was 2,5-dimethyl-2,5-Di(tert-Butyl peroxy) hexane. The peroxide was fed via a high pressure pump through a spring loaded injector into heated barrel number 5. The maleic anhydride was manufactured by Huntsman Corporation and was melted from solid briquettes and injected as a molten liquid into the extruder via a heated high pressure injection pump and heated line through a spring loaded injector into heated Barrel number 3.

In all cases the solid feeds, whether 100% polypropylene or polypropylene together with various other components (e.g. Foral AX rosin acid), were fed into the cooled feed barrel and melted in a melting zone using standard kneading blocks. The screw elements used for the melting zone also acted as a dynamic melt seal to prevent the molten maleic acid being injected under pressure into barrel 3 from escaping out the feed throat.

In each case, the solid polypropylene feed or feed mixture (polypropylene and additives) was fed to the cooled feed barrel and conveyed forward and melted in the melting zone. The resulting molten polypropylene was then conveyed to a subsequent first mixing zone where molten maleic acid was injected and mixed to produce a maleic/polypropylene mixture. The maleic/polypropylene mixture was then conveyed forward to a second mixing/reaction zone where the peroxide initiator was injected and mixed with sufficient stirring for a sufficient time to allow the reaction to proceed to produce the maleated polypropylene or rosin acid-containing maleated polypropylene. Total time in the extruder was on the order of 2 to 5 minutes average residence time.

The two mixing zones were separated by a dynamic melt seal formed by using reverse conveying and blister ring screw elements at the end of the first mixing zone. The second mixing/reaction zone was similarly sealed at the end using reverse conveying and blister ring elements to prevent the maleic/polypropylene mixture from prematurely escaping the reaction zone. The molten maleated polypropylene or rosin acid-containing maleated polypropylene product was vacuum vented to remove volatiles in barrels 9 and 10 using a standard laboratory vacuum pump and dry ice trap system. Vacuum was 28 inches of mercury in for both vents in Comparative Example 1, 27 inches of mercury in both barrels 9 and 10 for Inventive Example 1, 28.5 inches in both barrels 9 and 10 in Inventive Example 2, 26.5 inches of mercury on both barrels 9 and 10 in Inventive Example 3, and 25 inches of mercury in both barrels 9 and 10 in Inventive Example 4. Molten maleated polypropylene or rosin acid-containing maleated polypropylene product was removed from the extruder through a standard 2 hole die heated to 205 C, followed by a standard stranding water bath and strand cutter. The strand cut pellets are cylindrical in shape.

In Comparative Example 1, no rosin acid or antioxidant was utilized. In Inventive Example 1, polypropylene pellets having a melt flow rate of 1.2 g/10 min was utilized in addition to 0.15% by weight Westin 619 antioxidant and 5% by weight Foral AX rosin acid produced by Eastman Chemical Company. In Inventive Example 2-4, the same amounts of Foral AX rosin acid were used, but the amounts of Westin 619 antioxidant were changed to 0.25% by weight in Inventive Example 2 and 0.3% by weight in Inventive Examples 3 and 4.

Table 1 summarizes the examples giving the feed composition, feed rates, and the acid number, Brookfield viscosity, and yellowness index of the maleated polypropylene or rosin acid-containing maleated polypropylene. It should be noted that the color as shown by the yellowness index of the rosin acid-containing maleated polypropylene in Examples 1-4 ranged from 19.5 to 23.8 while the color of Comparative Example 1 without the rosin acid was 50.1.

TABLE 1

| | | PP | Maleic | | | | | | | |
|---|---|---|---|---|---|---|---|---|---|---|
| | | Pellet | Acid | | | | Maleic | | | |
| | | Feed | Feed | | Peroxide | | Grafting | Brookfield | | |
| | Extruder | Rate | Rate | Feed Ratio | Feed Rate | Acid | Efficiency | Viscosity at | Yellowness | % |
| Example # | (RPM) | (#/hr) | (#/hr) | (Maleic/PP) | (#/hr) | Number | (%) | 190° C. | Index | Transmittance |
| Comparative 1 | 200 | 20 | 0.51 | 0.0256 | 0.220 | 10.4 | 72% | 31,000 | 50.1 | 34.7 |
| 1 | 200 | 22.5 | 0.51 | 0.0227 | 0.216 | 16.6 | 130% | 49,000 | 22.7 | 51.9 |
| 2 | 200 | 24.5 | 0.51 | 0.0209 | 0.209 | 16.4 | 140% | 58,300 | 19.0 | — |
| 3 | 200 | 24.5 | 0.51 | 0.0209 | 0.209 | 17.1 | 146% | 41,000 | 23.8 | — |
| 4 | 200 | 24.5 | 0.51 | 0.0209 | 0.209 | 16.0 | 136% | 53,000 | 23.8 | — |

### Comparative Example 2 and Examples 5-8

### Production of Maleated Polyproplene Emulsions

A direct or batch process was used in these examples to produce the maleated polypropylene emulsions. The maleated polypropylene, non-ionic surfactant, neutralizing base, water, additives, and rosin acid (either added to the charge or contained in the polypropylene) were charged to a 300 ml Parr reactor to produce an emulsification mixture. Table 2 gives the amounts charged to the reactor. The amount of the non-ionic surfactant and carboxylic acid co-surfactant are expressed in terms of parts of ingredient per 100 parts of maleated polypropylene (phr) charged to the reactor. The neutralizing base was dimethylamino-2-methylpropanol (DMAMP-80) used as an 80% solution (20% water). The remainder of the batch charge was water, and various low levels of additives for stabilizing the color and pH of the maleated polypropylene emulsion. The color additives included hypophosphorous acid and sodium metabisulfite (SMB). Potassium hydroxide (KOH) was also added. Brij 30 and Brij 72 non-ionic surfactants obtained from Uniquema Chemical Company were utilized in these experiments.

The reactor was heated quickly to 140° C. and then heated at about 1.5 degrees per minute to the emulsification temperature shown in Table 2. At the emulsification temperature, the reactor was stirred at 400 rpm. After the emulsification time as shown in Table 2 was complete, the reactor was cooled down at 1 to 2 degrees per minute from the emulsification temperature to 1350, then cooled rapidly. The emulsion was discharged through a fine paint strainer having a 48×64 mesh filtration area after cooling to 55° C. or lower.

The color of the samples with Foral AX rosin acid and Weston 619 was much better than the color of the Comparative Example. Despite the lower maleic acid and peroxide level in the examples having Foral AX rosin acid added during the maleation, emulsions were obtained with higher % transmittance than the comparative example where Foral AX rosin acid was added during the emulsification. All the emulsions using samples with Foral AX rosin acid added during the maleation emulsified at relatively low temperatures, had minimal residue, filtered very rapidly indicating minimal amounts of larger emulsion particles to blind the filter, and had very good % transmittance considering the low graft level.

TABLE 2

| | Example No. | | | | |
|---|---|---|---|---|---|
| | Comparative 2 | Ex. 5 | Ex. 6 | Ex. 7 | Ex. 8 |
| Water | 139.3 | 139.3 | 139.3 | 139.3 | 139.3 |
| 50% | 0.5 | 0.5 | 0.5 | 0.5 | 0.5 |
| Hypophosphorous | | | | | |
| Acid | | | | | |
| KOH | 0.2 | 0.2 | 0.2 | 0.2 | 0.2 |
| SMB | 0.2 | 0.2 | 0.2 | 0.2 | 0.2 |
| DMAMP-80 | 5.8 | 5.8 | 5.8 | 5.8 | 5.8 |
| Foral AX-E rosin | 3.0 | — | — | — | — |
| acid added to | | | | | |
| charge | | | | | |
| Foral AX-E rosin | — | 3.0 | 3.0 | 3.0 | 3.0 |
| acid in | | | | | |
| polypropylene | | | | | |
| Oleic Acid | 4.5 | 4.5 | 4.5 | 4.5 | 4.5 |
| Brij 30 non-ionic | 7.5 | 7.5 | 7.5 | 7.5 | 7.5 |
| surfactant | | | | | |
| Brij 72 non-ionic | 2.0 | 2.0 | 2.0 | 2.0 | 2.0 |
| surfactant | | | | | |
| Maleated PP (g.) | 57.0 | 60.0 | 60.0 | 60.0 | 60.0 |
| Maleated PP | Comp. 1 | Ex. 1 | Ex. 2 | Ex. 3 | Ex. 4 |
| Type | | | | | |
| Emulsification | 171 | 171 | 163 | 168 | 162 |
| Temperature | | | | | |
| (° C.) | | | | | |
| Emulsification | 60 | 60 | 60 | 60 | 60 |
| Time (Min.) | | | | | |
| Emulsion Yield | 213.5 | 214.3 | 214.4 | 215 | 215.9 |
| (g. out of 220 g | | | | | |
| start) | | | | | |
| Residue (g.) | 1.5 | ˜1.0 | 1.3 | 0.5 | Trace |
| Filtration Speed | Fast | V. Fast | V. Fast | V. Fast | V. Fast |
| % Transmittance | 39.4 | 60.9 | 63.5 | 67.1 | 67.5 |
| (1% emulsion) | | | | | |

The invention has been described in detail with particular reference to preferred embodiments thereof, but it will be understood that variations and modifications can be effected within the spirit and scope of the invention.

That which is claimed is:

1. An alicyclic carboxylic acid-containing functionalized polyolefin comprising at least one alicyclic carboxylic acid and a functionalized polyolefin.

2. An alicyclic carboxylic acid-containing functionalized polyolefin according to claim 1 wherein said functionalized polyolefin is maleated polypropylene.

3. An alicyclic carboxylic acid-containing functionalized polyolefin according to claim 2 wherein said alicyclic carboxylic acid is rosin acid.

4. A functionalized polyolefin emulsion comprising at least one alicyclic carboxylic acid-containing functionalized polyolefin, at least one non-ionic surfactant, at least one carboxylic acid co-surfactant, at least one neutralizing base, and water.

5. A process for producing an alicyclic carboxylic acid-containing functionalized polyolefin comprising contacting at least one polyolefin, at least one functionalizing agent, at least one alicyclic carboxylic acid, and at least one initiator to produce said alicyclic carboxylic acid-containing functionalized polyolefin.

6. A process for producing an alicyclic carboxylic acid-containing functionalized polyolefin according to claim 5 wherein said contacting is conducted in an extrusion zone.

7. A process for producing alicyclic carboxylic acid-containing functionalized polyolefins comprising: 1) heating at least one polyolefin and optionally, at least one alicyclic carboxylic acid, in a melting zone to produce a molten polyolefin; 2) contacting said molten polyolefin with at least one functionalizing agent and optionally, at least one alicyclic carboxylic acid, in a first mixing zone to produce a functionalizing agent/polyolefin mixture; 3) contacting said functionalizing agent/polyolefin mixture with at least one initiator and optionally, at least one alicyclic carboxylic acid in a second mixing/reaction zone to produce the alicyclic carboxylic acid-containing functionalized polyolefin.

8. A process according to claim 7 wherein said polyolefin is polypropylene.

9. A process according to claim 7 wherein said functionalizing agent is maleic anhydride.

10. A process according to claim 7 wherein said alicyclic carboxylic acid is rosin acid.

11. A process for producing a functionalized polyolefin emulsion comprising contacting an alicyclic carboxylic acid-containing functionalized polyolefin, at least one non-ionic surfactant, optionally at least one carboxylic acid co-surfactant, at least one neutralizing base, and water

12. An article comprising said alicyclic carboxylic acid-containing functionalized polyolefin of claim 1.

13. An article comprising said functionalized polyolefin emulsion of claim 4.
